(19) United States
(12) Patent Application Publication
(10) Pub. No.: US 2015/0095070 A1
(43) Pub. Date: Apr. 2, 2015

(54) System, Process and Article of Manufacture for Human Health and Longevity Data Analysis

(71) Applicants: Mitchell Jay NewDelman, Monaco (MC); Jodie Michelle NewDelman, San Geronimo, CA (US)

(72) Inventors: Mitchell Jay NewDelman, Monaco (MC); Jodie Michelle NewDelman, San Geronimo, CA (US)

(21) Appl. No.: 14/503,887

(22) Filed: Oct. 1, 2014

Related U.S. Application Data
(60) Provisional application No. 61/885,413, filed on Oct. 1, 2013.

(51) Int. Cl. G06F 19/00

(52) U.S. Cl. CPC G06F 19/363; G06F 19/322
USPC 705/3

(57) ABSTRACT

A system, process and article of manufacture includes the generation of a “BIG Data” set of searchable submissions of biographical and/or physical identity inputs by interested persons with knowledge of deceased third parties; or by self-disclosing individuals to be released either during the lifetime of the submitter (Inter-Vivos) or Post Mortem (PM), each knowing that the consequent anonymous Big Data set comprised of all released submissions will be made accessible to researchers. Submissions are solicited via proprietary questionnaires, developed and rigorously validated using established techniques in behavioral science, statistics and informatics. Since data contained in questionnaire(s) enters the proprietary Big Data set if and when the subject of the questionnaire is dead, a key element of the process is the opportunity for living family members or friends to complete an initial proprietary questionnaire to preserve for the deceased a “Continuity of Identity.” That first questionnaire initiates a profile of biographical and/or physical identity data of the deceased subject accessible at (or remotely from) the respective cemetery or specific place of Post Mortem corporal disposal. Consequently, the living responder is thereby encouraged to begin the assemblage of their own inter-vivos proprietary questionnaire submissions to be released into the proprietary Big Data set either Inter-Vivos or Post Mortem. The method exploits known software techniques to merge quantifiable data fields from all submissions of proprietary questionnaires, thereby creating a researchable Big Data set.

### CROSS REFERENCE TO RELATED APPLICATION

This application is based on and contains disclosure from U.S. Provisional Application Ser. No. 61/885, 413, filed Oct. 1, 2013 in the names of Mitchell Jay NewDelman and Jodie Michelle NewDelman, the disclosure of which is hereby incorporated by reference herein.

### FIELD OF THE INVENTION

The present invention relates to a computer implemented system, process and article of manufacture for integrating human lifestyle and related personal identity information with medical patient data. More particularly, it relates to such a system, process and article of manufacture in which an individual's survey responses are integrated with his or her patient data to allow data analysis for identifying correlations between lifestyle/personal identity data and patient data.

### BACKGROUND OF THE INVENTION

Informatics as a field of science has been evolving for at least 50 years but at an accelerating pace that roughly tracks the decreasing costs of computation, internet connectable devices (including photography and/or videography and/or medical imagery devices) and searchable data memory storage and known retrieval systems. Significantly lowered data storage and retrieval costs was the precursor of the phenomenon of Big Data sets; including collections of individuals' medical records held by custodians at public and private hospitals, university health facilities, health insurers, government health systems and similar repositories. These existing and expanding health related Big Data sets are increasingly used for research purposes.

Psychographic, demographic, genetic and life-style preference sub-sets of data are often solicited from selected groups for specific correlations; such as the well-known Farmington study: http://en.wikipedia.org/wiki/Framingham Heart Study and the lesser known and very recent study on correlations of a fish diet and hearing loss in females: Curhan, Eavey, et al. Fish and fatty acid consumption and the risk of hearing loss in women: Am J Clin Nutr November 2014 ajcn.091819; First published online Sep. 10, 2014. doi:10.3945/ajcn.114.091819.

At this time, social media is accumulating massive personal data but with neither a method useful to the science of Informatics; nor a process to search massive heterogeneous data generated randomly by social media participants.

The demographic phenomenon of social media today has an age bias to teenagers and young adults under 50 years old. Therefore the present time is ideal for a novel teaching as this massive demographic age medium wave curve as the social media universe approaches retirement age of say +65 years of age.

Books, records and certain digital data exist for searching facts concerning specific historical figures and certain more recently deceased persons. This sort of necrology is the extent of a deceased person's history and biography that can be searched. These data are practically useless for input into any larger collection of similar data on other deceased persons since it is not searchable by field. Currently, necrologies cannot be merged for analysis of resulting data sets of comparable facts since such data is either not collected or not collected in a manner to be easily researched. Instead, much organized data preservation is limited to notable figures. Even then, information encumbered by the form of preservation, as written biographies by 3rd parties, auto-biographies, or a collection of works on a subject, is challenging to codify.

No collection of biographies can be currently searched per se for use in Informatics. However, the concept of searching into the lives of ancestors is a discernible human activity as shown by the success of genealogy and ancestry record preservation and related search engines. As an extension, individuals in the modern area have used technology to deepen human connectivity by (perhaps unwittingly) releasing a staggering amount of biographical data into a still broadening array of social media networks. In either case (whether input is self-disclosed or referential) the current virtual arenas are unwieldy and present challenges for use in informatics analysis, where the purpose transcends market research and consumer targeting.

If all internet users on-line at any given moment is considered as a big data set, data mining happens every second of everyday via cookies, market analysis of click-troughs et cetera in order to present shoppers with customized choices. In that sense, big data mining is happening, but for use ‘in vivo’ to manipulate consumer behavior.

Thus, there is an established trend demonstrating human amenability (or willingness to accept discernible identity information probing in return for internet access to many sites) to participate in the utility of some limited identity data collection. Recognizing this phenomenon, we teach a business method or process that solicits submitters to divulge and preserve one's imprint (their respective Identity, not just life style preferences) on the world even though they were never a celebrity (or other notable person).

Our current technological age may be viewed as the tipping point for users motivated to leave a mark on the world or at least make a contribution to science with their Identity as data thereby obtaining a form of Continuity of Identity by the preservation of their Cid-Data. There has never been a place; nor has there been a reason, for preserving non-celebrity or non-professional biographical data inputs until our teaching that provides both a social rationale and a practical facility to submit personal data for memory preservation and for the advancement of human knowledge.

Certain cemeteries have licensed (or developed) web-based sites and physical kiosks to allow visitor interrogation concerning the location of gravesites of named individuals. These programs are proprietary by copyright or otherwise to their respective developer. These known programs allow for limited data about the deceased individual beyond final resting place location such as year of birth and year of death; and sometimes a photo of the tomb stone.

Certain of these computerized cemetery kiosks can be remotely web accessed. For example, the links below represent the State of the Art in gravesite identification as part of visitor's on-site or virtual experience. Further, one's interest in visiting a cemetery, viewing a tombstone, or gathering limited necrology data is obtainable at a distance. Despite the usefulness of such kiosk data for ancestry or genealogy research, the format and lack of aggregation make it impossible to apply Informatics.

Arlington National Cemetery (USA): http://www.arlingtoncemetery.mil/GravesiteLocator/GravesiteLocator.aspx Israelite cemetery in Geneva Switzerland (CH): http://www.acub.ch/?f=1&s=workEthernal Other cemeteries with some information on their celebrity status occupants are Père-Lachaise (Paris http://www.pere-lachaise.com/perelachaise.php?lang=en); Forest Lawn (Los Angeles http://www.forestlawn.com/); Staglieno (Genoa Italy http://www.staglieno.com/).

We distinguish our teachings from service offerings that might at first seem vaguely comparable; such as http://www.ancestry.com and affiliates and/or http://www.deceasedonline.com. These services acquire public records for people prepared to pay to view or print information on specific deceased persons, family names or other groups. In such limited, unstandardized, and un-accumulative formats, these services are also useless for Informatics.

We distinguish our teachings from what has become known as HIT (Health Information Technologies) that has an altogether different purpose affecting the health of living persons or health of individuals by their research into their ancestors' searchable medical records.

We also recognize, yet clearly distinguish, self-managed archiving of personal data such as random social media inputs. All such systems, by definition are not searchable since each individual saves different data and saves that data differently. Social media networks such as Facebook and LinkedIn are similar to self-managed archiving; and similarly can provide little if any useful searchable data for Informatics.

### SUMMARY OF THE INVENTION

For the purposes of this document, the following terms used in this description are defined as follows:

“CiD” means “Continuity of Identity” in the form of data inputs by an individual of Continuity of Identity data or “CiD Data” defined below by a taught method or process.

“CiD Data” is unlimited personal and family related historic and current data inputs by way of a submitter's “Q-Inform” responses even if interrogatory language seems irrelevant and represents some or all of one person's Identity as of the latest edition of one's Cid-Data.

“CiD Data Set” as used herein means a proprietary large researchable data set compiled from merged CiD Data derived from responses to Q-Inform submissions.

“Cemetery” as used herein means any place of Post Mortem corporal disposal, interment, cremation or other disposal.

“Continuity of Identity” is an intellectual construct and as used herein, means the quasi permanent researchable recording of subject-specific biographical and/or physiographical data inputs derived from responses to Q-Inform and if also submitted, other images or memorabilia currently not searchable by technical means related to the specific identify being preserved as data.

“Cid-Code” is the unique access key to view some or all of a specific individual's Cid-Data where a Cid-Code could be a password or similar access control.

“Cid-Cloud™” means the accumulated and/or merged but anonymous Cid-Data. Cid-Cloud™ may be accessed by use of an assigned Cid-Code for “memorabilia” and specific Q-Inform submissions stored within such Cid-Cloud™ on a CiD-Code controlled manner only by the original submitter or by related or unrelated 3rd parties authorized by the submitter.

“Informatics”, as used herein, means Human Health and Longevity Informatics

“Inter-vivos” means any act done by a person while alive.

“Pod” or “Pods” are geographically distinct locations of archives of medical records, typically to be found at hospitals, universities, health maintenance organization, government health agencies or similar institutions.

“Q-inform” means a proprietary Questionnaire submitted by a submitter that: a) contains some CiD-Data about a deceased person; or b) contains some CiD-Data of the submitter.

It is an object of this invention to provide a system, process and article of manufacture which will establish a repository for data on individuals that represents their respective CiD-Data which repository remains accessible for the foreseeable future to the submitter or to persons authorized by the submitter including persons using the appropriate and legitimately obtained Cid-Code for access.

It is a further object of the invention to provide such a system, process and article of manufacture which will establish a Cid-Data Set that can be accessed anonymously for search and research including necrology, biography, ancestry and/or genealogy as well as for Informatics.

It is another object of the invention to provide such a system, process and article of manufacture which will establish a cross-searchable Big Data set composed of a Cid-Data Set and the corresponding medical records archives of some or all of the persons in the Cid-Data Set that can be accessed anonymously for Informatics search and research and/or for government health policy decision makers, and/or legitimate commercial purposes.

It is another object of the invention to provide such a system, process and article of manufacture which will establish a cross-searchable or cross-researchable network of more than one Big Data Sets described immediately above composed of geographically separated medical records archives (Pods) that can be accessed anonymously for Informatics and/or for government health policy decision makers, and/or legitimate commercial purposes.

It is still another object of the invention to provide such a system, process and article of manufacture which will facilitate the foregoing including but not limited to applications on current and future internet connected devices any one or several of which may be used by any submitter of a taught Q-Inform, and in particular, but not by way of limitation, mobility and/or other interactive devices exploiting voice and/or image and/or avatars.

In accordance with the invention, a system for generating a database of combined user personal identity questionnaire responses and user patient medical history data includes at least one user device configured to administer a user personal identity survey. The user device is coupled to a medical center patient database system to supply results of the personal identity survey to the medical center patient database system. The patient database system is configured to combine the results of the personal identity survey with the user patient medical history data. At least one researcher system is coupled to receive the database of the combined results of the personal identity survey and the user patient medical history data. The researcher system is configured to identify correlations in the database between the combined results of the personal identity survey and the user patient medical history data for a plurality of users.

Further in accordance with the invention, a process for generating a database of combined user personal identity questionnaire responses and user patient medical history data includes administering a user personal identity survey with a user device. Results of the personal identity survey are combined with the user patient medical history data in a medical center data processing system for a plurality of users. The combined results of the personal identity survey and the user patient medical history for the plurality of users are supplied to a researcher system. Correlations in the combined results of the personal identity survey and the user patient medical history are identified for the plurality of users in the researcher system.

Still further in accordance with the invention, an article of manufacture for generating a database of combined user personal identity questionnaire responses and user patient medical history data includes at least one non-transitory computer readable storage medium having stored therein a first program segment for administering a user personal identity survey with a user device. A second program segment combines results of the personal identity survey with the user patient medical history data in a medical center data processing system for a plurality of users. A third program segment supplies the combined results of the personal identity survey and the user patient medical history for the plurality of users to a researcher system. A fourth program segment identifies correlations in the combined results of the personal identity survey and the user patient medical history for the plurality of users in the researcher system.

The attainment of the foregoing and related objects, advantages and features of the invention should be more readily apparent to those skilled in the art after review of the following detailed description of the invention, taken together with the drawings, in which:

### BRIEF DESCRIPTION OF THE DRAWINGS

FIG. 1 is a flow diagram to introduce the concept of Continuity of Identity to families having a family member of advanced age; close to death or otherwise recently deceased.

FIG. 2 is a flow diagram to introduce the teaching of Cid-Clouds to the custodians of “Pods”.

FIG. 3 is a selection of Identity defining questions from the Q-Inform interrogation process that may seem to be irrelevant queries: others will concern dietary and drug regimens; locations where the subject spent considerable periods of time; occupations and hobbies and many other sub-sections to develop one's Identity.

FIG. 4 is a high level block diagram of one example of a system suitable for practicing the process of the invention.

FIG. 5 is an example of a notice useful with the invention.

### DETAILED DESCRIPTION OF THE INVENTION

There is an established trend demonstrating human amenability (or willingness to accept discernible identity information probing in return for internet access to many sites) to participate in the utility of some limited identity data collection. Recognizing this phenomenon, we teach a business method or process that solicits submitters to divulge and preserve one's imprint on the world even though they were never a celebrity (or other notable person).

Our current technological age may be viewed as the tipping point for users motivated to leave a mark on the world or at least make a contribution to science with their Identity as data thereby obtaining a form of Continuity of Identity by the preservation of their Cid-Data. There has never been a place; nor has there been a reason, for preserving non-celebrity or non-professional biographical data inputs until our teaching that provides both a social rationale and a practical facility to submit personal data for memory preservation and for the advancement of human knowledge.

From the bottom up one perspective, the CiD teaching is a novel method to preserve genealogical and historical context for individuals. From the top down perspective, amassing a continuously expanding searchable Informatics Big Data set prevents the constant loss through death of crucial trend and anomaly information relevant to human progress.

By providing searchable CiD-Data sets alone or merged with existing medical record archives to be harnessed and exploited by the emerging science of Informatics, the colossal anonymous aggregate of such individual searchable Cid-Data from the broad general population will inform researchers in countless disciplines.

Recognizing a probable under-appreciated and surely unfulfilled desire for some form of Continuity of Identity post mortem, our teaching on method exploits an anticipated positive reception from family, friends or other interested persons eligible to submit a 3′ party Q-inform with known data about deceased persons. If executed with psychological sensitivity, the submitter of data for a deceased person will be induced to initiate an Inter-vivos version of Q-inform for eventual input into a Cid-Data Set either Inter-Vivos or Post Mortem.

Alternatively or concomitantly, the practice of the teachings would be facilitated through specific solicitation of living adults whose medical records are being maintained by a hospital, university, HMO, government agency or similar institution. Such adults, if they retain adequate mental competence can establish their own CiD archive accessible by their own Cid-Code™ by initiating and submitting the then current version of Q-Inform™ as a former or current patient having locatable archived medical records.

HIT is mentioned since eventually most HIT systems may represent additional harvestable data provided the owner of the data; including the subjects themselves, grants permission for such data to be added to one's Cid-Data Set in a subsequent searchable Q-inform submission.

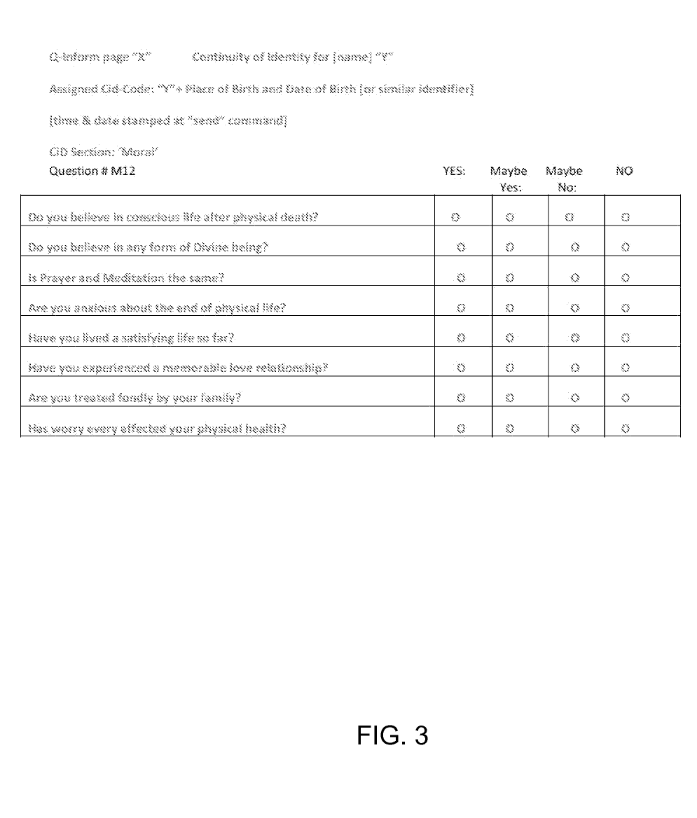

From the current state of the art in Medical Informatics generally, academia has long discussed and debated the issue of the submission of data by medical professionals versus submission of data by the individual patient. Since the Q-informs are scientifically designed to pose questions that a medical professional may find irrelevant (See FIG. 3), we teach that Q-informs, even having medical history questions, are more accurate than the same form submitted by a medical or psychology professional having only the patients current objective data.

One leveling technology visible on the horizon are individual physical monitoring devices and could eventually represent an historic data record that could be interrogated by future interactive iteration of a Q-inform when such devices become ubiquitous for a future generation. This space is generally known as ‘quantified self’. However, there are so many specific types of devices and bodily functions capable of being monitored and quantified that any systematic interface for anonymous data up-loading for purposeful Informatics is impossible at this time.

Our Q-Inform teaching is not for social exchange. In fact, Q-Informs are not supposed to be merged or searched until the subject is dead or is intentionally ‘released’ in whole or in part as a Cid-Data Set for their permitted visitors having been given the relevant Cid-Code; and/or an anonymous inter-vivos contribution to a Cid-Cloud associated to a Pod for Informatics use.

Informatics is now an established ‘discrete’ research tool. By discrete, we mean data collection from a known population universe to determine if specific correlations exist or not. For example, See: Curhan, Eavey, et al. Fish and fatty acid consumption and the risk of hearing loss in women Am J Clin Nutr November 2014 ajcn.091819; First published online Sep. 10, 2014. doi:10.3945/ajcn.114.091819. Our teaching includes the new utility for Informatics and in particular as additional Pods are added for geographic regional research and comparison for region-biased CiD-Data Sets.

Using a Pod's existing archived medical records and patient lists and Q-Informs reduces “incidental endogeneity” of data inputs to significantly enhance statistical accuracy and computational efficiencies. See: Fan, Han, Liu, Challenges of Big Data analysis, National Science Review, 1: 293-314, 2014 doi: 10.1093/nsr/nwt032. For ease of reference: http://arxiv.org/pdf/1308.1479.pdf

In brief, algorithmic dimension reduction methods enhance accuracy. The novelty of Q-Inform data sub-sets for personal identity data input is not a known business model and the innovative ‘device’ is the Q-Inform even if interactive technical progress modifies delivery of queries and recovery of responses.

A further feature of the invention is the evolving platform toward uniformity of collected CiD Data Sets into the Pod-related Cid-Clouds for eventual inter-Pods Informatics research and dialogue.

Another feature of the invention is a business process of encouraging living family, friends and other interested, knowledgeable persons to complete (even partially) a Q-Inform regarding a deceased individual. Participation is rewarded with free cloud based web-space for the uploaded collections of additional biographical memorabilia. Though memorabilia formats are not particularly useful for Informatics with current technology, the process of completing a Q-Inform will certainly enhance the experience related to Continuity of Identity since the submitter herself (or himself) will probably one day face their own issue of identity continuation for descendants.

Further, it is hypothesized that as an artifact of participation on behalf of a loved one, the grieving process is facilitated in a way that both honors the deceased and fortifies the responder. We recognize that the non-Q-inform memorabilia may be audio, video or other images that can be tagged for some future 3rd party research.

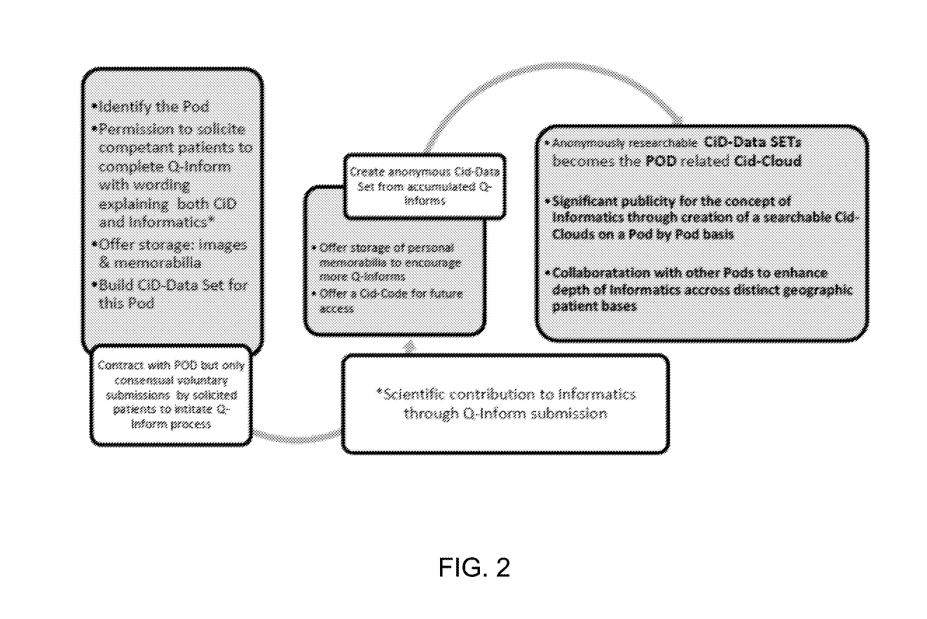

D) A business model of the invention is the unique revenue generation potential for access to a proprietary and constantly expanding searchable CiD-Cloud or collaborating Cid-Clouds amongst Pods. See FIG. 2.

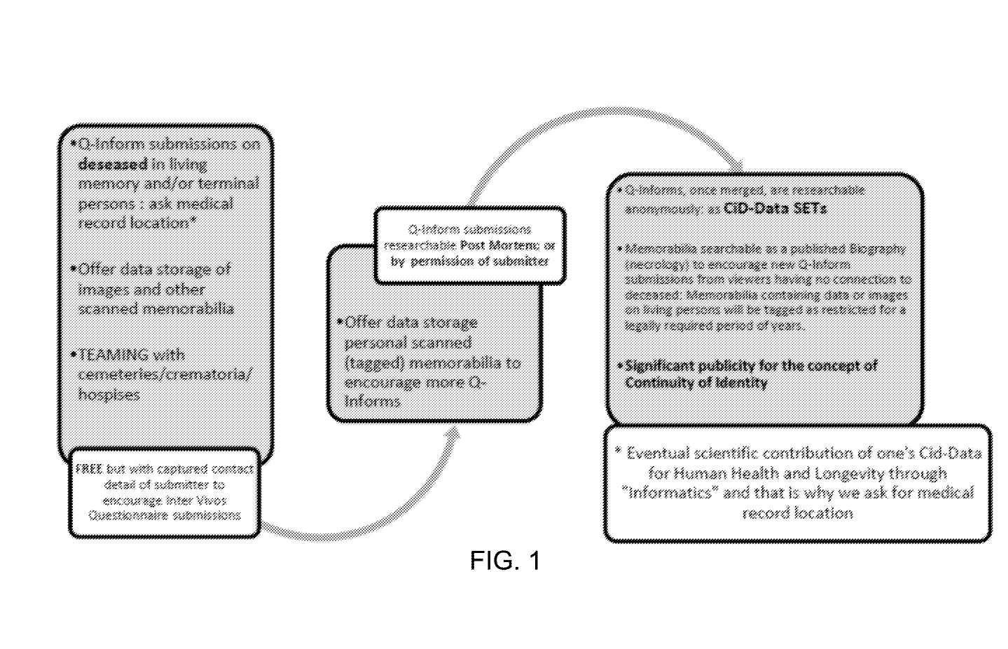

F) A further business model is of a mutually advantageous series of teaming agreements with cemeteries to encourage their participation and dissemination of the Q-Informs (links or physical printed materials) to family and friends of deceased cemetery occupants to enhance to the quality of the visitor's experience, whether physically present or virtually visiting the cemetery. See FIG. 1.

Enablement has much to do with a strategic teaming relationships with custodians of medical records willing to participate in the scientific but voluntary submissions of Q-Informs from living patients whose medical records are within that institution's or agency's control.

Existing archives data formatted medical records are practically all regional or national databases; such as the University of Chicago's Center for Research Informatics “regional reach” or the U.K. National Health Service's medical database covering most of England. Pods of existing medical databases can be useful for comparisons. The uniformity of Q-Informs, notwithstanding language and cultural translations will allow geographical Pods to be compared for an eventual further layer of Informatics knowledge.

Informatics is an emerging science derived from earlier work that predicted the potential of exploiting appropriate Big Data sets. It is for this reason that Q-Informs will most likely also evolve and expand over time to provide statistically better CiD-Data Sets thereby making the Pods more valuable to qualified researchers.

Currently there is no commercial, standard and research-useful way of collecting Inter-vivos biographical or physical data from individuals. The consequent loss of data results from the lack of a ubiquitous, user-friendly solution for saving one's critical identity data for quasi-perpetual Post Mortem accessibility.

Our unique business Process and Business Method differs significantly from classic biography, auto-biography or other ‘vanity’ self-publication since no Memorabilia destined for one's Cid-Data Set will be accepted without a companion Q-Inform submission. The Q-Inform is not obvious to anybody skilled in the art of writing obituaries, biographies or even auto-biographies.

Social media like Facebook and LinkedIn are cultural phenomena for interaction and shared personal or professional data. Occasionally an individual's page remains accessible Post Mortem. Although current social media sites maintain categories of personal data, they do not format such data for functional use to generate researchable data for human health and longevity Informatics research. Social media information requests do not remotely resemble the probing for useful identity inputs of our taught Q-Inform. Further, social media neither emphasizes nor proposes the utility of Post Mortem profile accessibility to ‘friended’ and/or other ‘non-friended’ 3^{rd} parties Post Mortem.

Admittedly, social media might generate culturally interesting data from its diverse universe of captured personalized biographical content. Yet, without the preexisting structures in place to validly collect and codify researchable responses such as taught in the Q-Inform method, the utility of collective member profiles are exploited, if at all, only for current or near future commercial reasons only.

Some social media services provide for memorialization of a subscriber's account upon death. One embodiment of our business method provides for a transfer of a deceased person's social media page provided somebody (including the social media page owner while alive) creates a CiD-Data-Set by submission of an Informatics friendly proprietary questionnaire: the Q-Inform. Since one's CiD-Data Set (essentially the reasonably completed Q-Inform) is essentially a private biography (necrology, when dead), descendants who review an ancestor's CiD-Data Set or Q-Inform thereby become a prospective inter-vivos submitter, encouraged to activate web hyperlinks connecting and enhancing an expansive ancestral or “related-to” network.

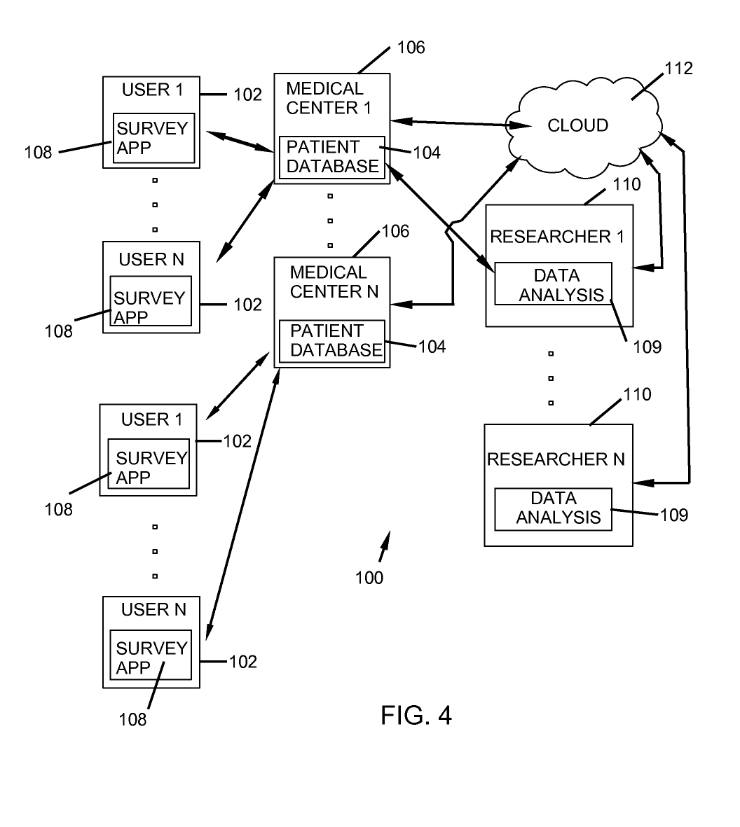

FIG. 4 schematically represents one example of a system 100 that can be used to practice the invention. User devices 102 are coupled to patient database systems 104 maintained in medical center computer systems 106. The user systems 102 each include a survey application 108 configured to administer the Q-Inform questionnaire. Alternatively, the survey questionnaire could be made available to the user devices 102 via a website provided by the medical center systems 106. The user devices 102 can be, for example, desk top computers, laptops or tablets.

When a user completes the Q-inform questionnaire, it is uploaded to the patient database system 104, where it is integrated with the user's medical record maintained by the medical center 106. The combined data from the user Q-inform questionnaire and the user's medical record is only available to others without identification of the user unless the user has authorized release of his or her identity. Once data from a number of users has been integrated with their medical records, the resulting data set is available to a researcher who is affiliated with that medical center 106 for statistical analysis purposes by a data analysis program 109 in a researcher system 110. Such data from a number of users can be used, for example, to look for correlations between the Q-inform data and medical conditions in user medical records.

Periodically, the medical center system 106 uploads the combined data sets from the questionnaires and the medical records to data cloud 112, where combined data sets from a number of medical center systems 106 are maintained. A researcher affiliated with one of the medical centers can also access the data sets from his or her medical center along with the data sets from other medical centers from the data cloud 12. A researcher not affiliated with any medical center can also access the data sets in the data cloud.

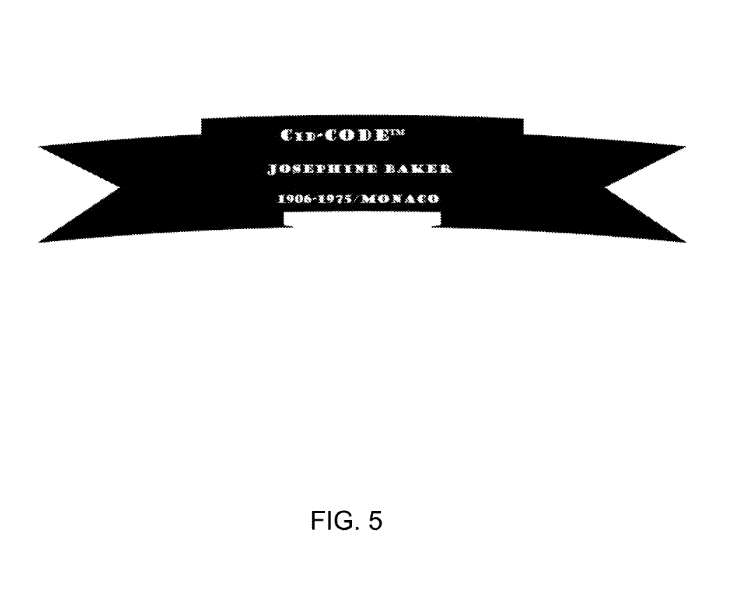

Search engines and social media will be induced to apply the Cid-Code tag (see FIG. 5). When any person's name is searched along with a date of birth or date of death; the tag serves as a link to the corresponding CiD-Code. For example: If somebody searched a telephone directory for “Josephine Baker”, many Josephine Bakers appear. For the well-known entertainer of the 1930's, a search would surely show: 1906 (USA)-1975 (France) buried at the Cimetière de Monaco. By using a Cid-Code™ of for a different Josephine Baker, she may be found regardless of the common name and even though she was not a celebrity. For every individual who shares a name, perhaps even with someone notable, the Boolean searching of CiD-Codes pinpoints the unique person's CiD records by combining variables such as Date of Birth, Date of Death, and/or final resting place (a named cemetery, for example) as part of the target's personal Cid-Code™.

Further details of an embodiment of the invention are available in an example of a Q-inform questionnaire, which is an appendix to this application.

It should now be readily apparent to those skilled in the art that a novel system, process and article of manufacture capable of achieving the stated objects of the invention has been provided.

A constantly growing body of individual CiD-Data Sets over time will become the corpus for CiD-Clouds and either alone or in collaboration with medical record archives; local, regional and eventually a global Informatics research network will be established for investigation into many relevant scientific subjects beyond the initial personal drivers and purposes of the CiD-Data submitters: one's biography for posterity.

Whereas the lives of individuals may pass naturally and unremarkably, each actually represents a substantial epidemiological, epigenetic and etiological data input. When correlated to medical records; theirs and thousands or millions of others within their Pod, the mutually searchable sub-sets become a significant contribution to Informatics science.

Q-Informs are a component of a machine or, if not a machine per se, they render the necessary ‘transformation’ of inputted data into a person's “CiD-Data Set” for subsequent interrogation by descendants and other authorized visitors and for anonymous up-loading into CiD-Clouds for Informatics and the consequent enhancement of human knowledge; all from otherwise irretrievable Identity data that normally is physiologically deleted at death of the individual.

As mentioned previously, social media adherents own their respective up-loaded data and images. Therefore no obstacle exists to solicit all social media participants to opt-in for an automatic transfer of their respective data to their respective CiD-Data Set to be effectuated at their demise. Transfer would be at no cost to the transferor per terms and conditions that would also provide that if this act of transfer occurred while alive; it would be an intervivos transfer. A condition for any inter-vivos transfer would be permission to access the submitter's medical records post mortem wherever found for eventual submission to a CiD-Cloud within a Pod.

The ultimate revenue source are fees generated from for-profit or from not-for-profit institutions seeking to mine data from our Cid-CLOUD alone or in association with the medical records located at a Pod. For example, a pharmaceutical company or an insurance company would pay more than a doctorate candidate researching an Informatics-generated link concerning a particular human disease or mental disorder.

It should further be apparent to those skilled in the art that various changes in form and details of the invention as shown and described may be made. The system, process and article of manufacture is described by way of example in a particular interconnected data processing system. The invention can be implemented in other system configurations capable of carrying out the described operations. It is intended that such changes be within the spirit and scope of this invention.

### APPENDIX TO NEWDELMAN ET. AL. APPLICATION

### Sep. 30, 2014

“Q-INFORM” as used herein means a proprietary self-report inventory of dynamic items to extract identity data “facets” (or fields) which can be subsequently searched discretely for comparative and correlational research.

### Q-INFORM Concept

This proprietary form (Q-Inform) will be exhaustively researched and submitted for systematic statistical analysis for its ultimate purpose. In “test construction” research, inventories and questionnaires are rigorously examined for reliability and validation on a number of levels. Further analysis of parsimony is typically conducted to ensure ease of use. In this case, the Q-Inform instrument is NOT targeting a specific disorder or seeking to identify specific correlation. Instead, it will be designed to cast a wide net for the collection of a broad array of data elements, per individual, regarding their self-reported personal identity and lifestyle. Aggregated, this big data set matched with medical records will provide enormous utility for researchers on a vast array of unexamined (or under-examined) scientific topics within an informatics framework.
Q-Inform is designed for living persons, but may also be applied to the recently deceased using first-degree relative raters. Regardless, the Terms and Conditions are accepted by the submitter allowing for anonymous processing of input for informatics use. Death of the subject of the Q-Inform is the critical requirement for adding the inputted data to the big database. Any Q-Informs (submitted invivos) by the future subject can be cached by our program to be released into the Big Data set only upon confirmation of death through various means, or by consent of the subject individual.

### Measuring Personal Identity and Self Understanding

A broad area of research in itself, self concept research will guide the development of the final Q-INFORM. It is generally understood that personal identity is formed around basic needs for security and self esteem and the personal desires that flow from them. Pathological aberrations in the data set are to be expected. To gauge degree along continuums in each field, we will format the final inventory with a Likert type scale. Further, the tendency to “fake good” or “fake bad” in some respondents will be minimized with assurances that identifying data is reduced to a number (for the purposes of eventually matching records to corresponding established records in other databases).

### Q-INFORM Identity Categories (Proposed)

VITALS: Birth weight/length, Vaginal birth/C-section/Complicated, Physical Appearance (hair color/type, skin color, eye color), Physical gender
CHILDOOD DEMOGRAPHICS: DOB, Location of Birth, Formative Environment (Urban/Rural/Suburban/Military/Alternative (commune, etc.)) Geographic areas lived in for more than 1 year before age 18, Generational level in country of birth, Proximity to nuclear plant/high voltage tension lines, Number of language spoken at home of origin, House/Apartment, Own/Rent, S.E.S.
FAMILY OF ORIGIN: Maternal age at birth, Paternal age at birth, Paternal ethnicity, Maternal ethnicity (Caucasion/Hispanic/African American/Asian American/Pacific Islander/other), Paternal Highest Education, Maternal Highest Education, Psychiatric/Psychological/Medical conditions in members of family of origin.
CHILDHOOD FAMILY STRUCTURE: Birth Order, Singleton, Multiple (genders), Adopted, Step Siblings (genders), Half Siblings (genders), Adopted Siblings (genders), Age of blood related paternal/maternal grandfather/mother (age now/at death), Childhood Experience of Death of Sibling or Parent. Lived with Both parents/One parent/Split time between homes.
CHILDHOOD EXPERIENCE: Own bedroom/Shared bedroom, Firearms in home, Age at severe accident or injury (none/1-11/12-20), Trauma (physical/sexual violence/abuse, other), Neglect, Extensive Travel/Name Countries Visited, Immigration.
CHILDHOOD HEALTH (not in med record): Acne, Rashes, Excessive Dental Carries, Dental Fluorosis, Persistent Sweating, Nightmares, Vivid Dreams, Sleep Apnea, Snoring, Teeth Grinding/Clenching, Typical sleep Wake Cycle Times, Onset of puberty, Orthodontia, Alternative Treatment (chiropractic, homeopathic, naturopathic, acupuncture, other)
ADULTHOOD DEMOGRAPHICS: Cultural Environment (Urban/Rural/Suburban/Military/Alternative (commune, etc.)) Geographic areas lived in for more than 1 year since age 18, Proximity to Nuclear Plant/High Voltage Tension Lines

### ADULTHOOD CULTURAL SELF CONCEPT: Gender Identity, Sexual Orientation, Educational Level

WORK IDENTITY: Blue Collar, Factory Work, Trades, Academics/Science, Business, Practicing Professional, Military, Full time employee, Business Owner, Property Owner, Homemaker, Creative Arts/Performer/Entertainer, Technology, Computing, etc. etc.
ADULT EXPERIENCE: Age at Trauma (injury/accident/combat, significant loss), Psychological/Axis 1 Disorders (Mood, Anxiety, Substance Related, Cognitive, Psychotic, Somatoform, Sleep Disorders, Eating Disorders).

### ADULT FAMILY IDENTITY: Married, Divorced, Separated, Coupled, Single, Number/Gender of Children, Large/Small Extended Family Relationships.

ADULT HEALTH CONDITIONS (may not be med record): Baldness/Patterns, Unwanted Facial/Body Hair, Halitosis, Persistent Sweating, Nightmares, Vivid Dreams, Sleep Apnea, Snoring, Teeth Grinding/Clenching, Typical Sleep-Wake Cycle Times/Duration, Onset of Menopause, Duration of Menopause

### Q-INFORM Lifestyle Categories (Proposed)

### PHYSICAL ACTIVITY: Required for Work, For Enjoyment, For Health, Sedentary, Active

DIETARY TENDENCY/CHOICE/OBLIGATION: Kosher, Halal, Vegetarian/Lacto/Lacto-Ovo, Vegan, Raw, Gluten Free, Paleo, Low Carb/High Protein, Low Fat/High starch, Fruitarian, Times of Day, Meals/Day
SUBSTANCE USE: Recreational Drug of Choice/Self Medication (unprescribed), Alcohol, Tobacco, Marijuana, Cocaine/Crack/Crank, Hallucinogens, Opiates, Methamphetamine/Crystal Meth, Other

### FOOD SENSITIVITIES and ALLERGIES: Food, Environmental, Hay Fever, Treatment, Severity, Symptoms, Intervention

THERAPEUTIC PRACTICE: Yoga, Meditation, Psychotherapy, Life Coaching, Counseling, Group (i.e. AA), Prayer, Other Spiritual Practice

### FINANCIAL PATTERNS: Spending Habits, Saving Habits, Investing Tendencies, Debt, Level of Consumerism

INTELLECTUAL ACTIVITY: Reading (fiction/nonfiction), Films (Documentary/Narrative), DIY projects, for Enjoyment/Work

### ENTERTAINMENT ACTIVITY: Passive/Active, Media/Live, Films, Plays, Musical Events

### MUSICAL GENRE OF CHOICE: Classical, Rock, Pop, Jazz, Traditional, Spiritual, Religious, New Age, Trance, House, Punk, Alternative, Heavy Metal, Grunge, Goth, Other

### RECREATIONAL ACTIVITY: Indoor/Outdoor, Social/Solitary, Active/Passive

### SPORT ORIENTATION: Engaged as Player, Engaged as Fan, Not Engaged, Which Sports, Team/Individual, Casual, Extreme

### MEDIA/WORK ACTIVITY: Hours/Day at Computer, Phone

### MEDIA/PLEASURE ACTIVITY: TV, Films, Information/Internet, Music, Gaming, Creating, Hours/Day

POLITICAL ORIENTATION: activist/uninterested, dem/rep party identity, conservative/liberal, green/environmentalist, Libertarian
DEVIANCE: Arrested, Incarcerated, (Types of offences)
RELIGIOUS ORIENTATION: Affiliated with Organized Group/Nonaffiliated, Identify but not Observant/Secular, Catholic, Protestant, Jewish, Islamic, Hindu, Buddhist, Other, Belief in God, Belief in Afterlife, Level of Traditional Observance (fasting, prescribed clothing, etc.).
WORLD VIEW: Naturalism (Atheism/Agnosticism/Existentialism/Evolutionism), Pantheism (Eastern/New Age/Consciousness/Oneness), Theism/Creationism (Intelligent design, Infinite personal God/People in the image of God/Absolute moral being), Spiritism/Polytheism (Gods/Demons/Spirit beings govern natural events and can be provoked) Postmodemism/Rationalist (reality and values interpreted through cultural paradigm/social constructionism empiricism) Humanist
AFFILIATIONAL STYLE: Collectivist/individualist/Isolationist, Community Group Membership, Civic Group Membership, Professional Group Membership, Other Club affiliation, Volunteerism (school, community, environmental/nature, religious, arts organization)
CHARITABILITY: Daily as a matter of Human Interaction, Systematically/Financially, To Support Pet Causes

### SOCIAL IDENTITY: Social Media Pages, Notable Acts, Publications, Accomplishments, Infamy

### Q-INFORM Personality Categories

This area requires parsimonious derivation using established techniques within the deeply researched fields of Trait Theory, Personality and Temperament. However, it is important to ask (though it may not be reliable) “Have you ever been told that you have a Personality (Axis II) disorder?”
Examples of state of the art inventories:
Minnesota Multiphasic Personality Inventory (MMPI-2) is a well-documented self-report instrument to identify personality type with more than 500 statements that assess a wide variety of topics including interpersonal relationships, abnormal behaviors and psychological health as well as political, social, religious and sexual attitudes.
The California Personality Inventory is based on the MMPI and is designed to measure such characteristic as self-control, empathy and independence.
The 16 Personality Factor Questionnaire (16PF) is used to generate a personality profile and support career choices. It was developed over several decades of research by Rayond Cattell Raymond B. Cattell, Maurice Tatsuoka and Herbert Eber using factor analysis to discover and measure the fundamental source traits of human personality. The test is an integral part of Cattell's comprehensive theory of individual differences. It measures 16 primary traits and the big 5 secondary traits giving a picture of the richness and complexity of each unique personality.
The Myers Briggs Type Indicator (MBTI) is a personality inventory to identify psychological types described by C. G. Jung. The questionnaire is designed to measure psychological preferences in how people perceive the world and make decisions. Self-report respondents are coded with 4 letters indicating the strength of correlation along four principal psychological functions: sensation, intuition, feeling, and thinking.
The Strong Interest Inventory (SII) if often used for educational and career counseling. It includes assessment along 124 occupational scales, 23 Basic Interest Scales, and 2 special scales to measure academic comfort and introversion/extroversion dimensions.

1. A system for generating a database of combined user personal identity questionnaire responses and user patient medical history data, which comprises at least one user device configured to administer a user personal identity survey, said user device being coupled to a medical center patient database system to supply results of the personal identity survey to said medical center patient database system, said patient database system being configured to combine the results of the personal identity survey with the user patient medical history data, and at least one researcher system coupled to receive the database of the combined results of the personal identity survey and the user patient medical history data, said researcher system being configured to identify correlations in the database between the combined results of the personal identity survey and the user patient medical history data for a plurality of users.

2. The system of claim 1 in which said user device is a tablet, laptop computer or desktop computer including a survey app.

3. The system of claim 1 in which said user device is configured to administer the user identity survey by a survey website.

4. The system of claim 1 in which said researcher system is coupled to receive the database of the combined results from the medical center database system.

5. The system of claim 1 in which said researcher system is coupled to receive the database of the combined results from a data cloud coupled to a plurality of medical center database systems.

6. A process for generating a database of combined user personal identity questionnaire responses and user patient medical history data, which comprises administering a user personal identity survey with a user device, combining results of the personal identity survey with the user patient medical history data in a medical center data processing system for a plurality of users, supplying the combined results of the personal identity survey and the user patient medical history for the plurality of users to a researcher system, and identifying correlations in the combined results of the personal identity survey and the user patient medical history for the plurality of users in the researcher system.

7. The process of claim 6 in which the survey is administered by a survey app in the user device.

8. The process of claim 6 in which the survey is administered by a website coupled to the user device.

9. The process of claim 6 in which the combined results are supplied to the researcher system from the medical center data processing system.

10. The process of claim 6 in which the combined results are supplied to the researcher system from a data cloud coupled to a plurality of medical center data processing systems.

11. An article of manufacture for generating a database of combined user personal identity questionnaire responses and user patient medical history data, which comprises at least one non-transitory computer readable storage medium having stored therein a first program segment for administering a user personal identity survey with a user device, a second program segment for combining results of the personal identity survey with the user patient medical history data in a medical center data processing system for a plurality of users, a third program segment for supplying the combined results of the personal identity survey and the user patient medical history for the plurality of users to a researcher system, and a fourth program segment for identifying correlations in the combined results of the personal identity survey and the user patient medical history for the plurality of users in the researcher system.

12. The article of manufacture of claim 11 in which the first program segment is a survey app in the user device.

13. The article of manufacture of claim 11 in which the first program segment is in a website coupled to the user device.

14. The article of manufacture of claim 11 in which the second program segment is in a medical center data processing system.

15. The article of manufacture of claim 11 in which the third program segment is in a medical center data processing system.

16. The article of manufacture of claim 11 in which the third program segment is in a data cloud coupled to a plurality of medical center data processing systems.

17. The article of manufacture of claim 11 in which the fourth program segment is in a researcher data processing system.
